(19) United States
(12) Patent Application Publication
(10) Pub. No.: US 2022/0259102 A1
(43) Pub. Date: Aug. 18, 2022

(54) CONGLOMERATE FOR MAKING ROAD PAVEMENTS,COMPOUND FOR MAKING THE CONGLOMERATE AND RELATED PRODUCTION METHOD

(71) Applicant: Alessandro Mondini, Ascona (CH)

(72) Inventor: Alessandro Mondini, Ascona (CH)

(21) Appl. No.: 17/630,578

(22) PCT Filed: Jul. 30, 2020
(86) PCT No.: PCT/IB2020/057185

§ 371 Date: Jan. 27, 2022

(30) Foreign Application Priority Data
Jul. 31, 2019 (CH) 00973/19

(51) Int. Cl. C04B 26/26; C04B 18/16; C04B 26/00; C04B 18/02

(52) U.S. Cl. CPC C04B 26/26; C04B 18/167; C04B 2111/0075; C04B 18/022; C04B 26/006

(57) ABSTRACT

A conglomerate for making road pavements is described, said conglomerate comprising a binder, preferably bitumen, a heavy inert material, preferably sand and/or gravel and/or filler, between 2.0% and 40% by weight of an elastomeric powder and/or granulate, and between 0.1% and 12% by weight of a thermoplastic polymer, preferably PE, PET or EVA in the form of granules or fibres; a method for making the conglomerate is also described, comprising the use of a compound which includes rubber powder and the polymer in suitable proportion.

### FIELD OF APPLICATION

The present invention relates to a conglomerate for making a road pavement, in particular a conglomerate comprising a binder, heavy inert material, an elastomeric material in the form of a fine powder and/or granulate, and a thermoplastic polymer.

### PRIOR ART

A conglomerate for road pavements is essentially a mixture of a binder and a heavy inert material, optionally including a filler. Generally, the binder consists of bitumen and the heavy inert material comprises sand and gravel and, when present, the filler.

A problem encountered in connection with the production of conglomerates for road pavements is represented by the reduction of noise. It is known that the rolling of tires emits a noise level higher than the engine even when running at a moderate speed, for example about 35 kilometres per hour. This problem is therefore strongly felt in the proximity of urban centres and in areas affected by intense or heavy traffic and moreover it has worsened considerably in recent years due to the increase in vehicle traffic and wheeled transport (increasingly heavier articulated lorries, etc.).

In an attempt to solve this problem, conglomerates were developed with the addition of a component consisting of a light inert material, such as volcano ash, pumice or expanded clay. It is common knowledge that the addition of a light inert material facilitates the laying of the conglomerate since it reduces the weight, provides greater plasticity and favours the application at relatively low temperatures. However, it has been found that to achieve a certain sound-absorbing effect, a relative high quantity of said light aggregate (for example expanded clay) is required, which increases the cost of the conglomerate.

The European patent EP 2 151 474 and Swiss patent CH 699 210, in the name of the present applicant, describe a conglomerate for making road pavements which contains 6% to 50% by weight of a light inert material and 0.5% to 5% of rubber powder and/or rubber granulate.

Another technique for reducing the rolling noise caused by vehicle traffic consists in making the pavement with a relatively high content of residual voids during laid typically between 12% and 16% so as to obtain a porosity on-site similar to that of the known drainage asphalts. However such pavement has the drawback of a significantly shorter lifespan than a traditional conglomerate, and the sound-absorbing effect is reduced over time due to the clogging of the pores. This phenomenon may also lead to a slippery road surface, especially in wet conditions, with deleterious effects on driving safety. This is therefore an unsatisfactory solution.

A further problem which arises in the construction of a road pavement is associated with the incentive to use recycled materials in view of cost and environmental impact aspects. For example, it is known to use fine rubber powder obtained from exhausted tyres (the disposal of which is notoriously an environmental problem). However the quantity of such fine powder added in the common conglomerates is modest and consequently the possibility of recycling is limited.

Conglomerates with a polymer mixed therein are known. Said polymer is added to increase the mechanical strength since the added polymer is known to improve the adhesion between the grains of the heavy inert material and the bitumen. In such type of conglomerates, the use of recycled polymers is known but in decidedly limited quantity.

In some embodiments of the prior art, it has been proposed to modify the bitumen (binder) with the addition of various components. This technique has the drawback of making the production of the conglomerate more complex since a special bitumen is required and for this reason is not very practical for on-site use. Furthermore, the added components in some cases give rise to environmental and/or health-related issues.

More in details, the technique of modifying the composition of the bitumen has the drawback that it cannot be easily applied and requires special infrastructures. The addition of rubber powder as a modifying agent for the bitumen also results in a significant increase in the viscosity of the bitumen itself. This marked increase in the viscosity of the binder affects the laying of the conglomerate on-site resulting in a more difficult application. Furthermore, according to the technical literature, the bitumen (binder) so modified may not be stored for more than 72 hours. Otherwise, the risk of separation increases considerably with negative consequences for the quality of the product. Furthermore, the added components, and in some cases also the (high temperature) processing conditions, may give rise to environmental and/or health-related issues.

### SUMMARY OF THE INVENTION

The technical problem underlying the present invention is to devise a conglomerate capable of reducing the noise arose by the rolling of tyres generally caused by the passage of motor vehicles, by trying to adopt solutions that are technically effective but also advantageous from an economic and environmental point of view, and which ensure a long duration over time, an optimum mechanical strength and good grip of the tyres. Another object of the invention is to simplify the production of a conglomerate with the aforementioned characteristics.

The problem is solved with a conglomerate according to claim 1. The conglomerate comprises an elastomeric material in an amount comprised between 2.0% and 40% by weight and a thermoplastic polymer in an amount comprised between 0.1% to 12.0% by weight.

A number of features and preferred formulations are described in the dependent claims.

The invention also relates to a method for the production of a conglomerate for road pavements according to the attached claims.

Another aspect of the invention relates to a compound or pellet according to the attached claims which contains the elastomeric material and the polymer in suitable proportions and is ready to use for the production of a conglomerate.

Another aspect of the invention relates to a method for making a road pavement using a conglomerate as described and claimed.

The idea behind the present invention is to reduce the noise emissions of a conglomerate by means of a suitable mixture of an elastomeric material and a thermoplastic polymer.

The elastomeric material is in the form of a fine powder or granulate. In the field, said fine powder or granulate of elastomeric material is usually referred to, for short, as rubber powder or granulate.

The particularly preferred amounts of the elastomeric material are the following: 2.0% to 12.0; 2.0% to 10.0%; 2.0% to 8.0%.

In some embodiments of the invention, the elastomeric material is present in an amount greater than or equal to 5.0% of the total weight of the conglomerate, more preferably in an amount greater than or equal to 8.0% of the total weight. Consequently, the elastomeric material may be present in an amount ranging from 5.0% or 8.0% up to 10.0% or 12.0% in various combinations. In some embodiments, a maximum of 30% or 20% instead of 40% may be envisaged.

The thermoplastic polymer preferably comprises one or more of the following: PE, PET, PP, PS, PVC, EVA. More preferably, it consists of PET or PE or EVA.

The elastomeric material and/or the polymer in some embodiments are at least partially obtained from recycling. For example, a recycled rubber powder or granulate is advantageously obtained from end-of-life tyres (ELTs). A recycled thermoplastic polymer may be obtained for example from recycled PET bottles or Tetra Pak type containers. Preferably, the elastomeric material is in the form of a fine powder or granulate obtained primarily or exclusively from end-of-life tyres.

The percentage amount of the various components may vary depending on the intended use of the conglomerate and in particular depending on the layer of the pavement for which the conglomerate is produced. For example, different formulations may be used depending on whether the conglomerate is intended to form a foundation layer, a base layer, an intermediate connecting layer or a surface layer. The surface layer is also known as the “wear layer”.

The conglomerate according to the invention has a first important advantage due to the fact that it can be easily produced at a low cost and shows a marked reduction in noise.

Owing to the combination of rubber powder or granulate and thermoplastic material, the conglomerate according to the invention may be made using unusually large amount of rubber powder or granulate and thermoplastic material. Since these materials may be obtained from recycling (for example from end-of-life tyres in the case of the rubber powder and from recycled bottles in the case of the PET), the invention allows increasing the use of recycled products with significant advantages in terms of cost and environmental impact reduction. This advantage is further increased in the embodiments which also use recycled asphalt.

The recycled thermoplastic polymer may contain traces of other recycled or waste products such as metals and paper. The applicant has found that these further traces of waste material, in the amounts normally present in recycled polymers, obtained for example from PET bottles, do not affect the performance of the conglomerate, in particular the reduction of noise according to the present invention.

The use of a compound or pellet containing the desired amount of rubber or polymer has the further major advantage of simplifying the production process and ensuring that is error-free thus obtaining consistent quality. In particular, the invention does not involve modification of the binder. A further advantage is that the compound according to the invention may be made exclusively using components which are not hazardous to health.

Further features and advantages will become clear from the description hereinbelow provided purely for illustrative and non-limiting purposes of the scope of protection of this application.

### PREFERRED EMBODIMENTS

According to a preferred formulation of conglomerate, in particular for making the wear layer of the road pavement, the weight of the elastomeric material is comprised between 2.0% and 12.0% of the total weight of the conglomerate, more preferably between 2.0% and 10.0% and even more preferably between 2.0% and 8.0%. The percentage amounts are always expressed in terms of weight unless otherwise specified.

The weight of the thermoplastic polymer is preferably comprised between 0.3% and 3.0% of the total weight of the conglomerate. Preferably, the polymer is PE, PET or EVA.

According to a preferred formulation of conglomerate intended to form a connecting layer, a base or a foundation layer of the road pavement, the elastomeric material has a weight comprised between 2.0% and 9.0% of the total weight of the conglomerate, and the polymer has a weight comprised between 0.1% and 2.0% of the total weight of the conglomerate.

According to an aspect of the invention, the conglomerate may comprise recycled asphalt which reduces the cost of the conglomerate. According to the common use the term “asphalt” refers to a bituminous conglomerate used for road pavement.

When recycled asphalt is used, the proportion of recycled asphalt compared to the total weight of the conglomerate may vary depending on the intended use of said conglomerate and more preferably is:

5% to 60% to make a surface layer or wear layer of the road pavement;

10% to 70% to make a connecting layer between two sections of the road pavement;

10% to 80% in the base layers;

10% to 90% in the foundation layers.

In a specific embodiment, the conglomerate comprises a fourth component consisting of a light inert material, preferably with a density less than 2.0 Mg/m³ and a bulk density less than 1.2 Mg/m³, and having a weight of 2% to 30% of the total weight of the conglomerate. In particular, said light inert material is used to increase the plasticity of the conglomerate and to improve laying even under a cold state. However, the conglomerate according to the invention may also be formulated in a version where the light inert material is absent.

The conglomerate according to the present invention may be made by means of a mixing method in which the components are inserted in the mixer device in the following sequence: first the heavy inert material; second the thermoplastic polymer and the elastomeric material, third the binder. The production of the conglomerate according to this method may be carried out in conventional plants suitable for the production of bituminous mixtures, which is an advantage because no special equipment is required. All the components are fed into the mixer following the sequence indicated above.

The elastomeric material and the thermoplastic polymer may be added, at least partially, during the manufacture of the conglomerate in the form of a compound consisting of granules or pellet. In one embodiment, all the elastomeric material and all the thermoplastic polymer used for the conglomerate are in the form of said compound or pellet.

In addition, according to another aspect of the mixing method, at least part of the elastomeric material and at least part of the thermoplastic polymer are aggregated in the form of a compound or pellet which advantageously contains the elastomeric material and the polymer in the desired proportion.

Preferably, the weight of the compound or pellet is comprised between, for example, 3% and 15% of the total weight of the conglomerate.

It should be noted that the proportions have been indicated as percentage; in the field for an immediate understanding, reference is often made to kg per tonne of conglomerate, where 1% corresponds to 10 kg per tonne. Therefore, for example a range from 2% to 12% corresponds to a weight from 20 kg to 120 kg per tonne.

Preferably, in the various embodiments of the invention, the binder (filler) content is not more than 12% by weight.

According to a further aspect of the invention, a ready-to-use compound or pellet is provided for making a conglomerate for road pavements, which contains the elastomeric material and the polymer in the desired proportions for a specific conglomerate formulation (for example for one of the uses already mentioned above).

Preferably, the elastomeric material in the compound has a weight quantity double or greater than the polymer.

Preferably, the compound comprises only the elastomeric material and the polymer without additives. The additives may be added to improve the workability, its dispersibility or to improve the final quality of the conglomerate. The compound may comprise at least 95% by weight which is the sum of the elastomeric material and the polymer, while the remaining 5% (or less) being represented by the aforementioned additives.

For example, the compound may comprise at least 70% by weight of elastomeric material, the remaining amount which makes up 100% consisting of the polymer and any additives. In a preferred embodiment, the compound comprises from 80% to 85% by weight of elastomeric material and correspondingly from 20% to 15% by weight of polymer and any additives. In a particularly preferred embodiment, the compound comprises 83% of elastomeric material and 17% of polymer and any additives.

The polymer in the compound may comprise any one of the following: PET, PP, PS, PVC, EVA. The elastomeric material in the compound is advantageously obtained at least partially from end-of-life tyres.

The elastomeric material in the compound is preferably in the form of a fine powder having granules not exceeding 2 mm in size.

### EXAMPLE

By way of example, the composition of a wear layers conglomerate according to the present invention is provided below; the Applicant has found excellent results in terms of noise reduction of the road pavement made with this composition and also in term of physical-mechanical characteristics, such as resistance to permanent deformation, resistance to fatigue and limited material loss.

Composition of the conglomerate for wear layers:

| | |
|---|---|
| Filler | 4% |
| Sand 0-2 mm | 4% |
| Sand 2-4 mm | 29% |
| Stone chippings 4-8 mm | 47% |
| Rubber powder | 7% |
| Recycled polyethylene in granular form | 1% |
| Bitumen | 8% |

1-28. (canceled)

29. A ready-to-use compound or pellet for making a conglomerate for road pavements, the ready-to-use compound or pellet comprising:
an elastomeric material; and
a thermoplastic polymer material in suitable proportions for making the conglomerate;
wherein a sum of the elastomeric material and the thermoplastic polymer constitutes at least 95% by weight of the compound or pellet, the compound or pellet including at least 80% by weight of the elastomeric material, the remainder up to 100% including said thermoplastic polymer material and any additives.

30. The ready-to-use compound or pellet according to claim 29 wherein the elastomeric material is present in an amount of 83% and said thermoplastic polymer material and any additives are present in an amount of 17%.

31. The ready-to-use compound or pellet according to claim 29 wherein the elastomeric material is present in an amount of 80% to 85% by weight.

32. The ready-to-use compound or pellet according to claim 29 wherein the elastomeric material is present in an amount of at least 85% by weight.

33. The ready-to-use compound or pellet compound of claim 29 wherein the elastomeric material is present in an amount of 80% to 85% by weight and said thermoplastic polymer material and said any additives are present in an amount of correspondingly 15% to 20% by weight.

34. The ready-to-use compound or pellet according to claim 29 wherein said thermoplastic polymer material is any one of the following: PE, PET, PP, PS, PVC, or EVA.

35. The ready-to-use compound or pellet according to claim 31 wherein said thermoplastic polymer material is EVA.

36. The ready-to-use compound or pellet according to claim 29 wherein the elastomeric material is at least partially obtained from end-of-life tyres (ELTs).

37. The ready-to-use compound or pellet according to claim 29 wherein the elastomeric material is in the form of a fine powder having granules not exceeding 2 mm in size.

38. A method for making a conglomerate for road pavement, wherein:
the conglomerate comprises a binder; a first component including a heavy inert material having a density greater than 2.0 Mg/m³; at least one elastomeric material in a form of a fine powder and/or granulate; at least one thermoplastic polymer in a form of granules or fibres; said at least one elastomeric material having a weight comprised between 2.0% and 40% of a total weight of the conglomerate, and said at least one thermoplastic polymer having a weight comprised between 0.1% and 12.0% of a total weight of the conglomerate;
the method comprising:
feeding components of the conglomerate into a mixer device, wherein the components of the conglomerate are fed into the mixer device according to the following sequence: first the heavy inert material; second the at least one thermoplastic polymer and the at least one elastomeric material, and third the binder;
wherein the at least one elastomeric material and the at least one thermoplastic polymer are added into the mixer in a form of a compound including granules, which comprises said at least one elastomeric material and said at least one thermoplastic polymer in a desired proportion;
wherein a sum of the at least one elastomeric material and the at least one thermoplastic polymer constitutes at least 95% by weight of said compound, the compound including at least 80% by weight of the elastomeric material, the remainder up to 100% including said thermoplastic polymer material and any additives.

39. The method according to claim 38 wherein said compound has a weight comprised between 3% and 15% of the total weight of the conglomerate.

40. The method according to claim 38 wherein, in the conglomerate, the at least one elastomeric material has a weight comprised between 2.0% and 12.0% of the total weight of the conglomerate.

41. The method according to claim 38 wherein, in the conglomerate, the at least one thermoplastic polymer has a weight comprised between 0.3% and 3.0% of the total weight of the conglomerate.

42. The method according to claim 38 for the making of a conglomerate for the realization of a connecting layer, wherein, in the conglomerate:
the elastomeric material has a weight comprised between 2.0% and 9.0% of the total weight of the conglomerate;
the polymer, which includes PE, has a weight comprised between 0.1% and 2.0% of the total weight of the conglomerate.

43. The method according to claim 38 wherein the conglomerate comprises recycled asphalt.

44. The method according to claim 43 wherein:
the weight of the recycled asphalt in the conglomerate is between 5% and 60% of the total weight of the conglomerate and the conglomerate is intended for the realization of a wear layer of the road pavement.

45. The method according to claim 43, wherein:
the weight of the recycled asphalt in the conglomerate is between 10% and 70% of the total weight of the conglomerate which is intended for the realization of a connecting layer of the road pavement.

46. The method according to claim 43, wherein:
the weight of the recycled asphalt in the conglomerate is between 10% and 80% or between 10% and 90% of the total weight of the conglomerate which is intended respectively for the realization of a bottom layer or the realization of a base above the bottom layer of the road pavement.

47. The method according to claim 38 wherein the at least one thermoplastic polymer is at least partially obtained from recycling, preferably of PET bottles or Tetra Pak type containers.

48. The method according to claim 38 wherein the conglomerate comprises a light inert material with a density lower than 2.0 Mg/m³ and a bulk density lower than 1.2 Mg/m³, said light inert material having a weight comprised between 2% and 30% of the total weight of the conglomerate.
